(19) United States
(12) Patent Application Publication
(10) Pub. No.: US 2006/0202138 A1
(43) Pub. Date: Sep. 14, 2006

(54) Level-handled type automatic shutoff faucet structure

(75) Inventor: Yung Yu Yeh, Changhua Hsien (TW)

Correspondence Address: TROXELL LAW OFFICE PLLC;SUITE 1404, 5205 LEESBURG PIKE, FALLS CHURCH, VA, 22041, US

(73) Assignee: Sunghao Metals Co., Ltd.

(21) Appl. No.: 11/106,565

(22) Filed: Apr. 15, 2005

(30) Foreign Application Priority Data
Mar. 11, 2005 (TW) 094203819

(51) Int. Cl. F16K 21/04

(52) U.S. Cl. 251/15

(57) ABSTRACT

A level-handled type automatic shutoff faucet structure includes an automatic shutoff valve made up of an outer cap, a water inlet valve, an inner stop valve, a central shaft, a water outlet valve, an adjustable piston, a fixing sleeve, a big spring, and a valve stem. The central shaft has a cylindrical hole for receiving the adjustable piston therein, and a thru-hole disposed at the bottom of the cylindrical hole thereof. The valve stem has a central adjusting cylinder to be respectively registered with the adjustable piston and the central shaft thereby, and a levelly flat stop face extending at the top surface thereon. Therefore, the distance between an adjusting section of the adjustable piston and the thru-hole of the central shaft can be accurately adjusted to regulate the time-length and the amount for water discharge, efficiently achieving the best application state thereof to prevent the waste of water resource.

### BACKGROUND OF THE INVENTION

The present invention is related to a level-handled type automatic shutoff faucet structure, including an automatic shutoff valve mounted to a faucet valve housing therein in operative linkage with an actuating control device wherein the automatic shutoff valve is made up of an outer cap, a water inlet valve, an inner stop valve, a central shaft, a water outlet valve, an adjustable piston, a fixing sleeve, a big spring, and a valve stem. The central shaft has a cylindrical hole defining the center therein for receiving the adjustable piston therein, and a thru-hole with a guide hole of a larger diameter disposed at the bottom of the cylindrical hole thereof in alignment with a needle-like adjusting section disposed at the lower section of the adjustable piston; the valve stem has a central adjusting cylinder with a set of stepwise upper and lower internal threaded sections defining therein to be respectively registered with the adjustable piston and the central shaft thereby; whereby, the distance between the adjusting section of the adjustable piston and the thru-hole of the central shaft can be accurately and speedily adjusted so as to regulate the time-length for water discharge as well as the amount of the water discharged, economically achieving the best using status thereof to prevent the waste of water resource.

Please refer to FIGS. 1 to 3 inclusive. A conventional automatic shutoff faucet structure is made up of a faucet body 10 and an automatic shutoff valve 20 (referring to FIG. 2) received at the faucet body 10 therein. The automatic shutoff valve 20 is made up of an outer cap 21, a return spring 22, a central shaft 23, a conic shape sealing ring 24, a water inlet valve 25, a positioning sealing seat 26, a water outlet valve 27, a water sealing ring 271, a fixing sleeve 28, a big spring 293, and a push button 29. In assembly as shown in FIG. 3, the return spring 22 is accommodated into a spring groove 231 disposed at the bottom side of the central shaft 23 thereof with a top needle 221 inserted into an air port 232 of the spring groove 231 thereof, and the conic shape sealing ring 24 is led through the central shaft 23 from the bottom to abut against a limiting portion 233 of the central shaft 23 thereof. The water inlet valve 25 is then guided through the central shaft 23 till an engaging portion 251 precisely registered with an engaging groove 241 of the conic shape sealing ring 24 thereof. The positioning sealing seat 26 is mounted to an annular sealing groove 234 of the central shaft 23 therein to synchronically locate the water inlet valve 25 thereby. The water sealing ring 271 and the water outlet valve 27 are respectively led and joined to the central shaft 23, permitting the water inlet valve 25 to accommodate at a receiving groove 272 of the water outlet valve 27 therein. Meanwhile, via the positioning sealing seat 26 of the central shaft 23 thereof, the water inlet valve 25 and the water outlet valve 27 are respectively sealed and separated in a position of closed state with water inlet ports 252 thereof corresponding to water inlet passages 273 thereof. Inserting holes 211 of the outer cap 21 thereof are then locked with non-illustrated inserting blocks of the water outlet valve 27, permitting water passages 212 of the outer cap 21 to communicate with the water inlet passages 273 of the water outlet valve 27 and the water inlet ports 252 of the water inlet valve 25 as well as a water-passage way 235 of the central shaft 23 thereof. Then, the fixing sleeve 28 is joined to the central shaft 23 with engaging flanges 274 of the water outlet valve 27 fitted into an engaging cavity 281 of the fixing sleeve 28 thereof, and an external threaded section 282 of the fixing sleeve 28 locked up to an internal threaded section 11 of the faucet body 10 thereby. Finally, the big spring 293 is mounted to a coupling end 291 disposed at the bottom of the push button 29, and an internal threaded hole 292 of the push button 29 is screwed up to an upper locking end 236 of the central shaft 23 so as to fix the push button 29 onto the central shaft 23 thereby, completing the assembly of a conventional automatic shutoff valve thereof.

There are some drawbacks to such conventional automatic shutoff faucet structure. Most of all, the pressure generated via the water flow going through the gap defined by the top needle 221 of the return spring 22 and the air port 232 thereof can have a relay effect to control the water discharged thereby. However, the gap formed by the top needle 221 and the air port 232 thereof is stably fixed in a certain size so that, with unchanged water pressure generated therewith, the time of relay for water discharge as well as the amount of water discharged cannot be flexibly adjusted according to the need, which is not only inconvenient in use, but can also result in a waste of water resource.

In addition, another conventional automatic shutoff faucet structure as disclosed in U.S. Pat. No. 6,311,948B1 is rather complicated in structure and the assembly parts, which is not only inconvenient and troublesome in assembly thereof, but can also boost the cost of material and processing thereof as well.

### SUMMARY OF THE PRESENT INVENTION

It is, therefore, the primary purpose of the present invention to provide a level-handled type automatic shutoff faucet structure, including an automatic shutoff valve mounted to a faucet valve housing therein in operative linkage with an actuating control device wherein, via a cylindrical hole and a thru-hole of a central shaft in communication with an adjusting cylinder of a valve stem for receiving an adjustable piston therein, the distance between a needle-like adjusting section of the adjustable piston and the thru-hole of the central shaft can be accurately and speedily adjusted so as to regulate the automatic shutoff valve and determine the time-length for water discharge as well as the amount of the water discharged as required, economically achieving the best using status thereof to prevent the waste of water resource.

It is, therefore, the second purpose of the present invention to provide a level-handled type automatic shutoff faucet structure wherein a guide hole of a larger diameter is provided extending beneath the thru-hole of the central shaft thereof so that when the actuating control device is stopped from the bending operation thereof, a valve stem influenced by the elastic return force of a big spring will be raised upwards thereby and actuate the central shaft to rise therewith. Meanwhile, water flow filling the space defined by an outer cap and a water outlet valve thereof will generate a pressure, concentrating along the guide hole thereof to smoothly push the central shaft upwards and gradually recover its former position of secure shutoff state thereof.

### BRIEF DESCRIPTION OF THE DRAWINGS

FIG. 1 is a perspective view of a conventional automatic shutoff faucet structure.

FIG. 2 is an exploded perspective view of the conventional automatic shutoff faucet structure.

FIG. 3 is a cross sectional view of the conventional automatic shutoff faucet structure in assembly.

FIG. 4 is an exploded perspective view of the present invention.

FIG. 5 is a cross sectional view of the present invention in assembly.

FIG. 6 is a diagram showing the adjustment of the present invention to regulate the amount of water discharged thereof.

FIG. 7 is a diagram showing the operation of the present invention in practical use.

FIG. 8 is a perspective view of the present invention assembled onto a washbowl.

FIG. 9 is another perspective view of the present invention assembled onto a washbowl.

FIG. 10 is a perspective view of the present invention assembled onto a urinal.

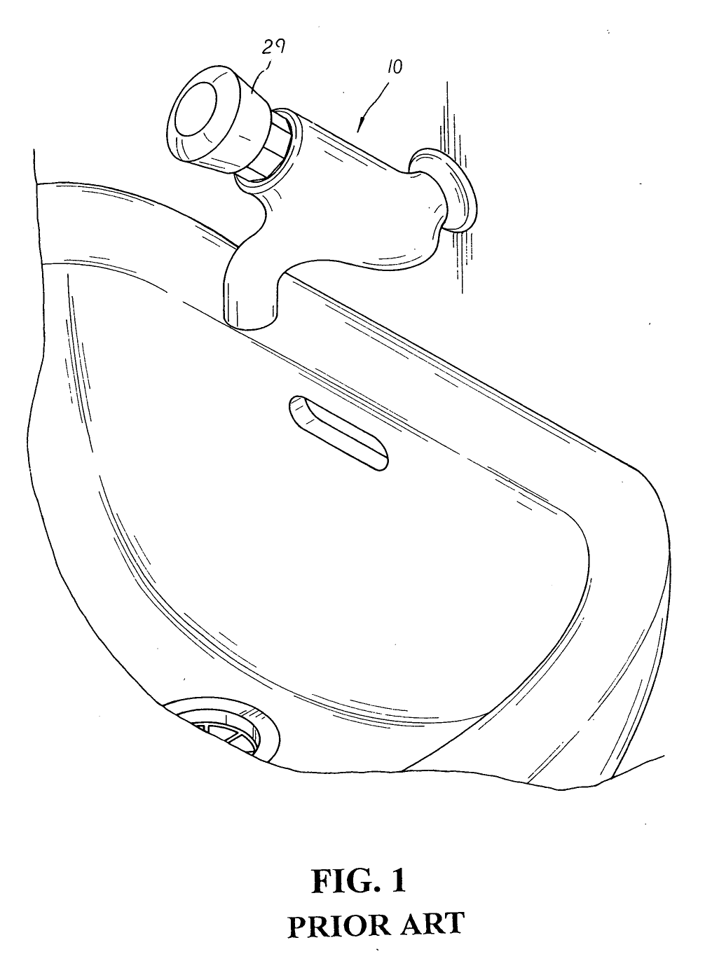

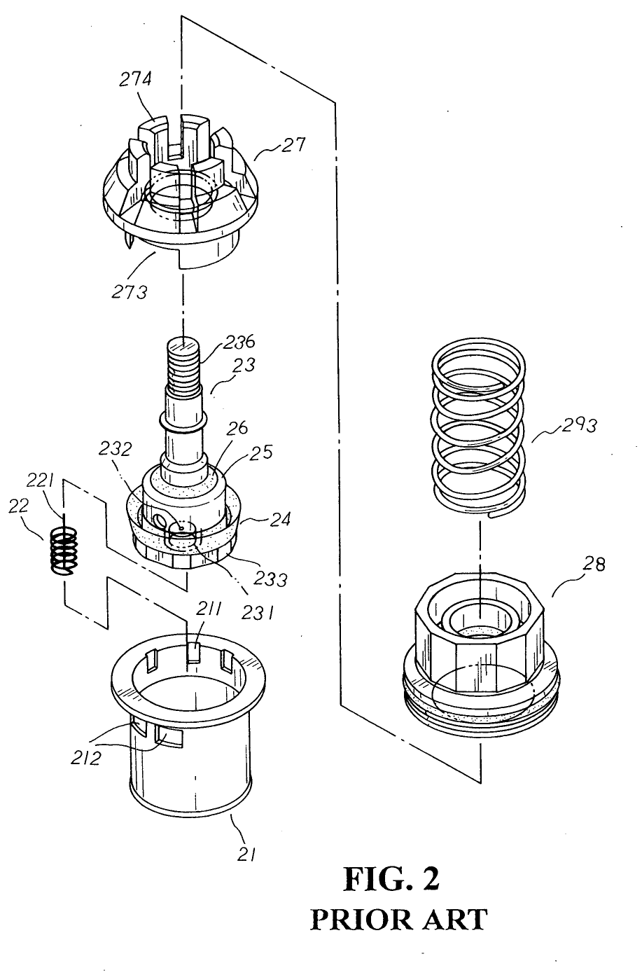

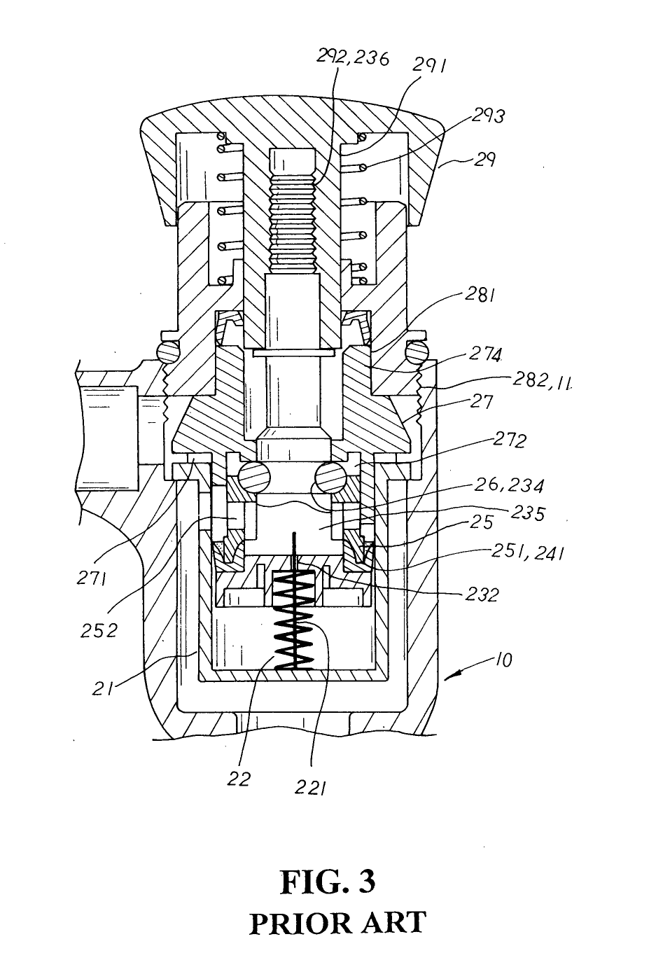

### DETAILED DESCRIPTION OF THE PREFERRED EMBODIMENTS

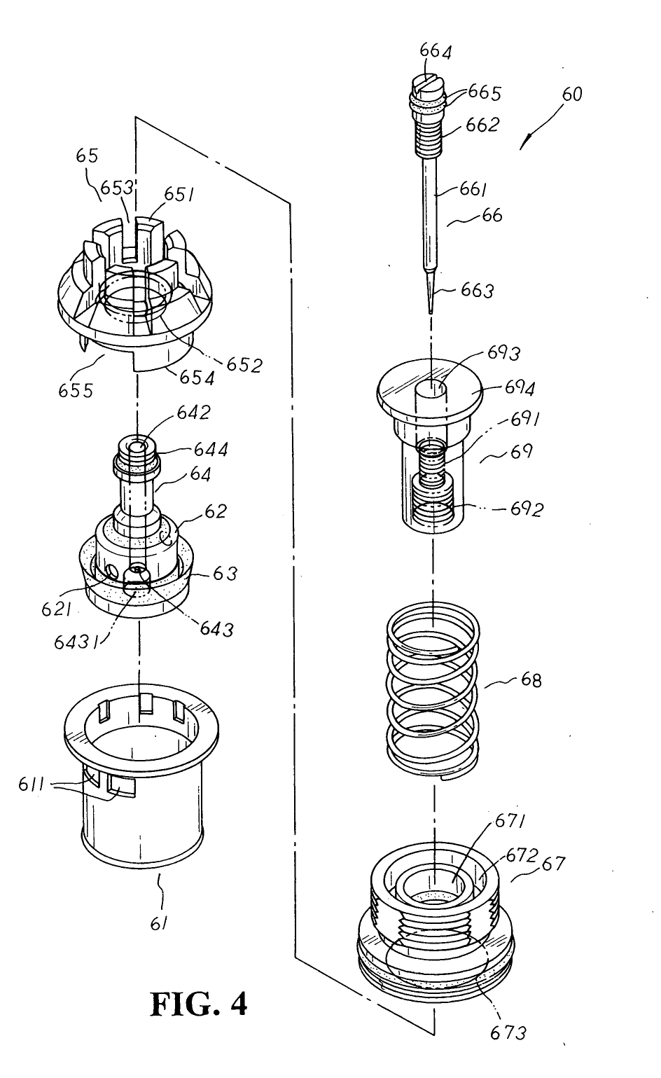

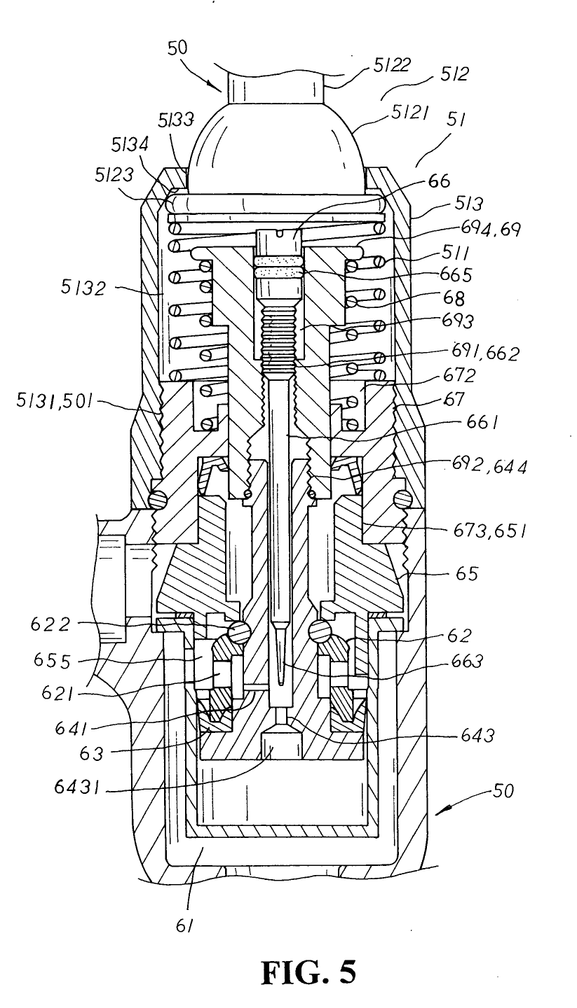

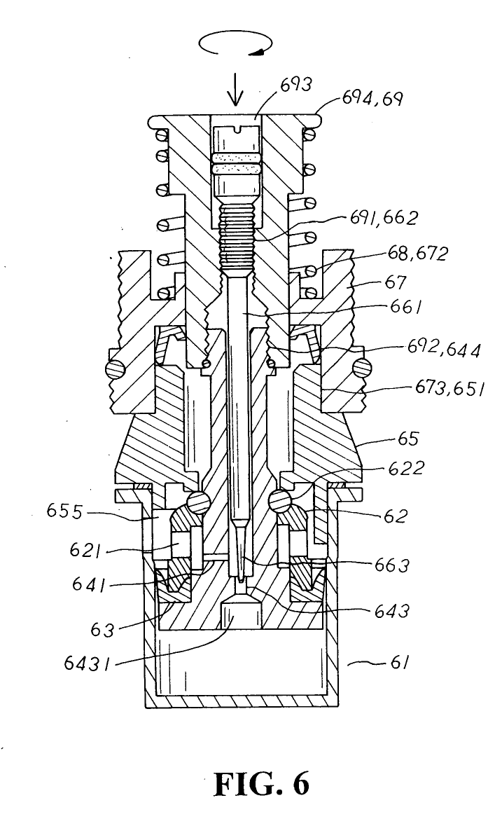

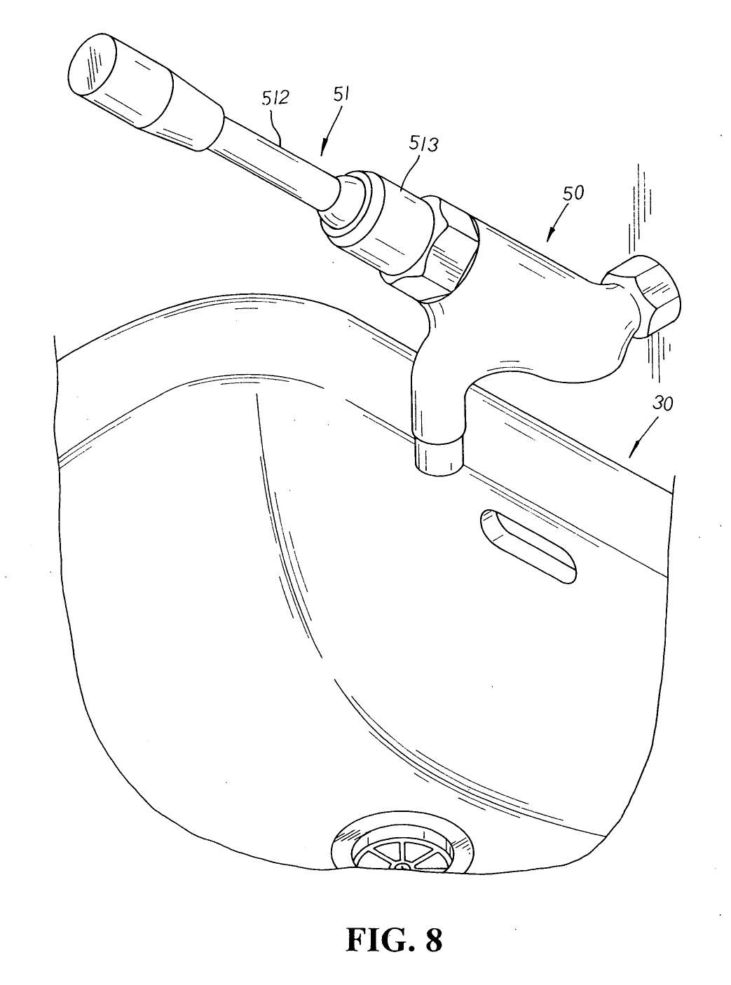

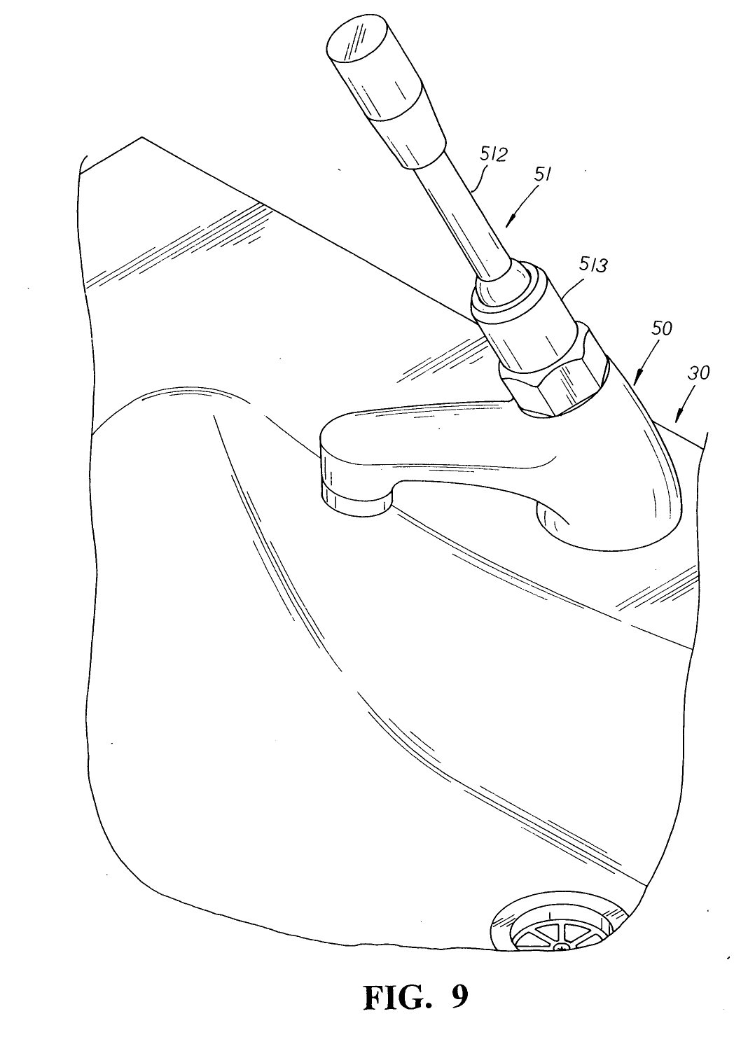

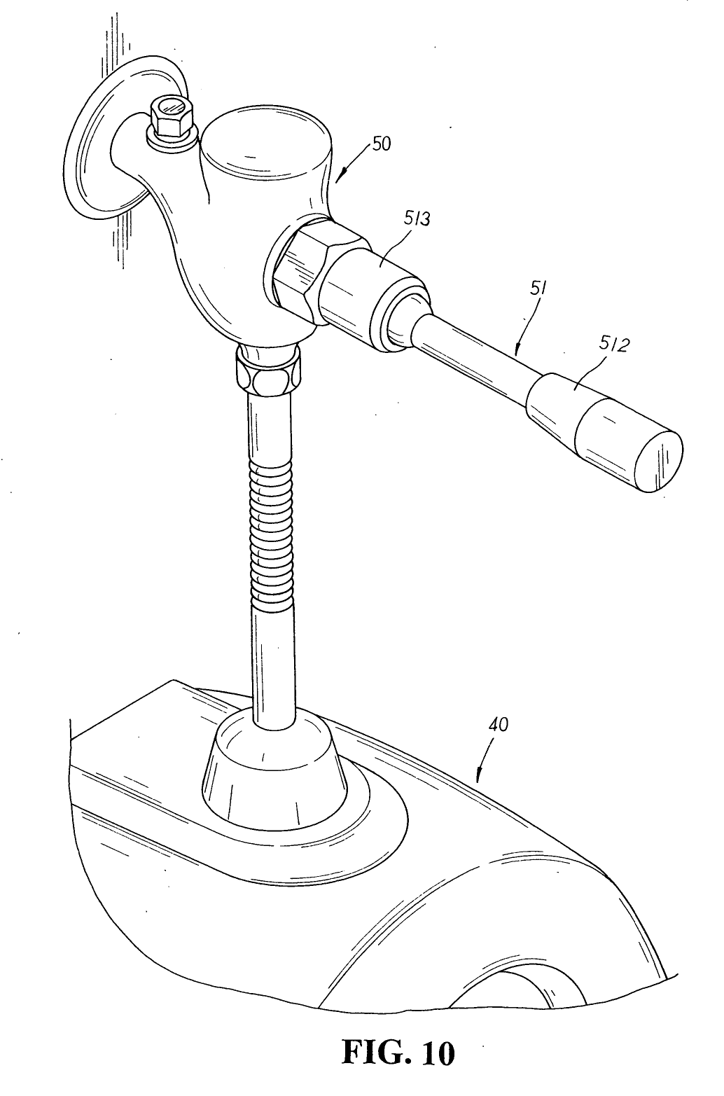

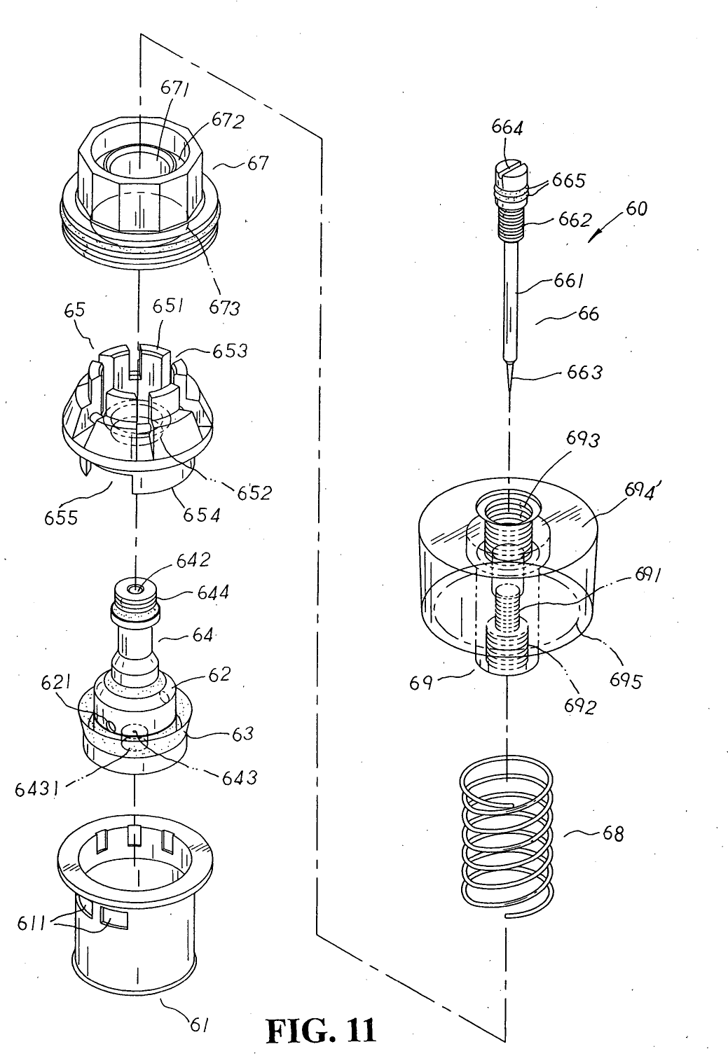

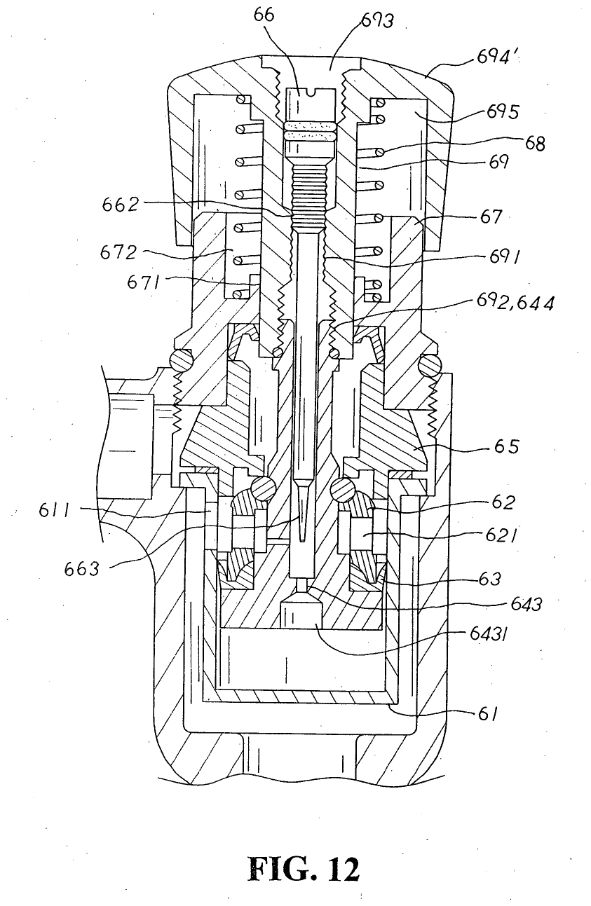

Please refer to FIG. 4 showing an exploded perspective view of the present invention. The present invention is related to a level-handled type automatic shutoff faucet structure, including an automatic shutoff valve 60 mounted to a faucet valve housing 50 of a washbowl 30 (referring to FIGS. 8, 9) and a urinal 40 (as shown in FIG. 10 in operative linkage with an actuating control device 51 thereby. The automatic shutoff valve 60 is made up of an outer cap 61, a water inlet valve 62, an inner stop valve 63, a central shaft 64, a water outlet valve 65, an adjustable piston 66, a fixing sleeve 67, a big spring 68, and a valve stem 69. The outer cap 61 has inlet holes 611 properly disposed at predetermined positions of the peripheral wall thereon, and the water inlet valve 62 and the inner stop valve 63 are sequentially mounted at the lower section of the central shaft 64 thereon. The central shaft 64 is equipped with a water passage 641 properly disposed at the peripheral wall thereon (referring to FIG. 5) and a cylindrical hole 642 defining the center therein in communication with water inlet ports 621 of the water inlet valve 62 thereby. At the bottom section of the cylindrical hole 642 of the central shaft 64 thereof is sequentially disposed a thru-hole 643 of a smaller diameter and a stepwise guide hole 6431 of a larger diameter extending downwards in communication with the thru-hole 643 thereof to form a funnel-shaped cross section thereby, and at the upper section of the cylindrical hole 642 thereof is disposed a stepwise external threaded portion 644. The water outlet valve 65 is equipped with a plurality of inserting flanges 651 protruding at the upper section thereof, a seat hole 652 defining the center thereof, a plurality of water outlet passages 653 radially cut at the periphery thereon, and a receiving cavity 654 with a water inlet opening 655 at one side indented at the lower section thereof. The adjustable piston 66 is made up of a pivoting rod 661 disposed at the middle section thereof, an external-threaded upper end 662, a needle-like adjusting section 663 disposed at the lower section thereof, a tool regulating groove 664 indented at the top surface thereon, and a sealing ring 665 properly mounted at a predetermined position thereon. The fixing sleeve 67 is equipped with a central through hole 671, an annular retaining groove 672 indented at the upper side thereon for receiving the big spring 68 therein, and an engaging cavity 673 disposed at the lower side therein. The valve stem 69 is made up of a central adjusting cylinder 693 with a set of stepwise upper and lower internal threaded sections 691, 692 defining therein to be respectively matched and registered with the external threaded upper end 662 of the adjustable piston 66 and the external threaded portion 644 of the central shaft 64 thereby. The valve stem 69 also includes a levelly flat stop face 694 extending at the top surface thereon.

Please refer to FIG. 5. In assembly, the seat hole 652 of the water outlet valve 65 and the central through hole 671 of the fixing sleeve 67 are sequentially led to mount to the central shaft 64 thereof, permitting the water inlet valve 62 to accommodate at the receiving cavity 654 in abutting location therein, and the inserting flanges 651 of the water outlet valve 65 to fit precisely into the engaging cavity 673 of the fixing sleeve 67 therewith. Then, the big spring 68 is adapted at the retaining groove 672 of the fixing sleeve 67 therein, and the valve stem 69 is guided through the center of the big spring 68 to pivotally receive at the central through hole 671 of the fixing sleeve 67 therein with the flat stop face 694 thereof compressing the big spring 68, permitting the central shaft 64 to accommodate at the adjusting cylinder 693 of the valve stem 69 therein with the lower internal threaded section 692 thereof mutually screwed up with the external threaded portion 644 thereof so as to align the cylindrical hole 642 and the thru-hole 643 of the central shaft 64 with the adjusting cylinder 693 of the valve stem 69 in reciprocal communication thereof. The pivoting rod 661 of the adjustable piston 66 is then guided from the adjusting cylinder 693 of the valve stem 69 to accommodate at the cylindrical hole 642 of the central shaft 64, permitting the needle-like adjusting section 663 to precisely locate in reciprocal alignment with the thru-hole 643 thereof. And the tool regulating groove 664 thereof is actuated via a tool to rotate the adjustable piston 66 therewith, permitting the external threaded upper end 662 thereof to screw up with the upper internal threaded section 691 of the valve stem 69. The inlet holes 611 of the outer cap 61 are reciprocally aligned with the water inlet opening 655 of the water outlet valve 65 to mount the outer cap 61 at the outer side of the receiving cavity 654 thereof, completing the assembly of the water-pressured type automatic shutoff valve 60 thereby. On top of the flat stop face 694 of the valve stem 69 is sequentially mounted a spring element 511, a movable rod 512, and a limiting sleeve tube 513 of the actuating control device 51 so that the valve stem 69 is reciprocally driven by the bending operation of the movable rod 512 in a linkage actuation therewith.

The spring element 511 of the actuating control device 51 (referring to FIG. 5) is joined to the outer side of the valve stem 69 and abutted against the edge of a locking section 501 of the faucet valve housing 50 at one end thereof. The movable rod 512, shaped in an annular rod, is equipped with a semi-spherical sliding guide member 5121 disposed at one end, a handle grip 5122 attached at the other end thereof, and a pressing disc 5123 of a larger diameter integrally protruding at the bottom edge of the sliding guide member 5121 thereon to precisely abut against the upper edge of the spring element 511 thereby. The limiting sleeve tube 513 is provided with internal threaded portion 5131 defining one end of the inner wall to be reciprocally screwed up with the locking section 501 of the valve housing 50 thereof to form an actuation space 5132 at the other end thereby, and a pivoting hole 5133 of a smaller diameter is disposed at the opening edge of the actuation space 5132 thereof to form a stop seat 5134 for limiting the pressing disc 5123 of the movable rod 512 that can be precisely located within the actuation space 5132 and elastically supported by the spring element 511 to abut against the stop seat 5134 with the sliding guide member 5121 accurately extending outside the pivoting hole 5133 thereof, facilitating a smooth and effortless operation of the actuating control device 51 for use of people, especially the elderly and the young ones. Therefore, via the spherical surface of the sliding guide member 5121 thereof, the movable rod 512 can be easily bent along the pivoting hole 5133 of the limiting sleeve tube 513 thereof and freely operated in 360 degrees, providing an ergonomic operation thereof to achieve the best using status thereof.

Please refer to 6. To determine the time-length for water discharge and the amount of water discharged, the needle-like adjusting section 663 of the adjustable piston 66 received at the cylindrical hole 642 of the central axial plug 64 therein is reciprocally regulated in position relative to that of the thru-hole 643 thereof. Thus, the adjusting piston 66 is simply rotated to adjust the distance between the adjusting section 663 and the thru-hole 643 thereof either longer or shorter in an accurate and speedy manner. In case of a longer distance adjusted there-between, the space defined between the thru-hole 643 and the adjusting section 663 will become relatively bigger and the water pressure gathered inside the increased space will quickly push the automatic shutoff valve 60 to rise upwards and shorten the time-length and amount of water discharge thereof. In case of a shorter distance adjusted there-between, the space disposed between the thru-hole 643 and the adjusting section 663 thereof will be reduced and the water pressure gathered inside the limited space thereof will push the automatic shutoff valve 60 to rise gradually at a slower speed, which in turn will increase the time-length and amount of water discharge thereof, economically achieving the adjustment of both time-length and amount of water discharge in a time/effort-saving manner without any assembly parts being dismantled for the purpose thereof.

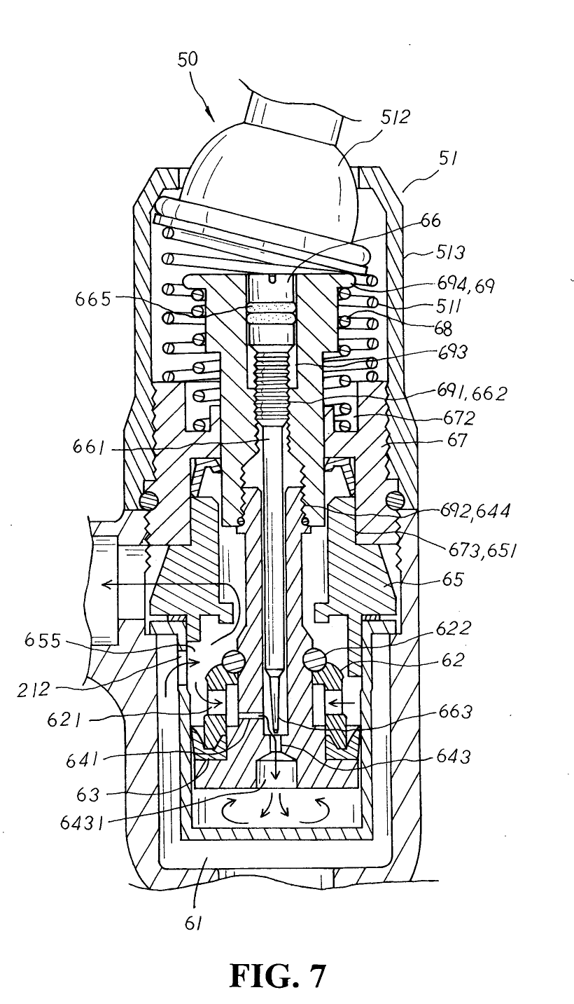

Please refer to FIG. 7. In practical use, the movable rod 512 of the actuating control device 51 is simply bent to synchronically press downwards the spring element 511, the valve stem 69, the big spring 68, the central shaft 64, the inner stop valve 63, and the water inlet valve 62 therewith, permitting the water flow gathering at the outer cap 61 and the water outlet valve 65 of the faucet valve housing 50 therein to generate a bigger pressure that will force the water inside the faucet valve housing 50 thereof to flow into the water inlet ports 621 of the water inlet valve 62 and the water passage 641 of the central shaft 64, and make the water to go through the adjusting section 663 of the adjustable piston 66 and flow directly downwards through the thru-hole 643 of the central shaft 64 to fill the space defined by the outer cap 61 and the water inlet valve 62 thereof with a return of the water flow generated at the limited space therein. Meanwhile, a water sealing O-ring 622 mounted at the water inlet valve 62 thereon and abutted against the seat hole 652 of the water inlet valve 62 can be detached from the seat hole 652 thereof with an opening revealed thereby, permitting water flowing through the seat hole 652 of the water inlet valve 62 to go out through the water outlet passages 653 thereof and discharge outwards there-from via a spout of the faucet valve housing 50 thereby. Once the actuating control device 51 is stopped from the bending force thereof, the flat stop face 694 of the valve stem 69 influenced by the elastic return force of the big spring 68 thereof will be raised upwards thereby and actuate the central shaft 64 to rise therewith. Meanwhile, the water flow still filling the space defined by the outer cap 61 and the water outlet valve 65 will generate a pressure to concentrate along the guide hole 6431 thereof and smoothly push the central shaft 64 upwards to gradually recover its former position with the water sealing O-ring 622 of the water inlet valve 62 precisely re-abutted against the seat hole 652 of the water outlet valve 65 so as to accurately shut off the water discharge thereby.

What is claimed is:

1. A level-handled type automatic shutoff faucet structure, including an automatic shutoff valve mounted to a faucet valve housing wherein the automatic shutoff valve is made up of an outer cap, a water inlet valve, an inner stop valve, a central shaft, a water outlet valve, an adjustable piston, a fixing sleeve, a big spring, and a valve stem; the present invention being characterized by that,
the central shaft being equipped with a water passage properly disposed at the peripheral wall thereon and a cylindrical hole defining the center therein in communication with water inlet ports of the water inlet valve thereby; at the bottom section of the cylindrical hole of the central shaft thereof being sequentially disposed a thru-hole of a smaller diameter and a stepwise guide hole of a larger diameter extending downwards in communication with the thru-hole thereof to form a funnel-shaped cross section therewith, and at the upper section of the cylindrical hole thereof being disposed a stepwise external threaded portion;
the adjustable piston, received at the cylindrical hole of the central shaft therein, being made up of a pivoting rod disposed at the middle section thereof, an external-threaded upper end, a needle-like adjusting section disposed at the lower section thereof, a tool regulating groove indented at the top surface thereon, and a sealing ring properly mounted at a predetermined position thereon;
the valve stem having a central adjusting cylinder with a set of stepwise upper and lower internal threaded sections defining therein to be respectively matched and registered with the external threaded upper end of the adjustable piston and the external threaded portion of the central shaft thereby, and a levelly flat stop face extending at the top surface thereon.

2. The level-handled type automatic shutoff faucet structure as claimed in claim 1 wherein the automatic shutoff valve is in operative linkage with an actuating control device made up of a spring element, a movable rod, and a limiting sleeve tube so that the valve stem is reciprocally driven by the bending operation of the movable rod in a linkage actuation therewith.

3. The level-handled type automatic shutoff faucet structure as claimed in claim 2 wherein the spring element of the actuating control device is joined to the outer side of the valve stem and abutted against one edge of the faucet valve housing thereof; the actuating rod, shaped in an annular rod, is equipped with a semi-spherical sliding guide member disposed at one end, a handle grip attached at the other end thereof, and a pressing disc of a larger diameter protruding at the bottom edge of the sliding guide member thereon to precisely abut against the upper edge of the spring element thereby; the limiting sleeve tube is provided with an internal threaded portion defining one end of the inner wall to be reciprocally screwed up with the valve housing thereof to form an actuation space at the other end thereby, and a pivoting hole of a smaller diameter is disposed at the opening edge of the actuation space thereof to form a stop seat for limiting the pressing disc of the actuating rod to precisely locate within the actuation space and flexibly support by the spring element to abut against the stop seat with the sliding guide member accurately extending outside the pivoting hole thereof.
